(19) United States
(12) Patent Application Publication
(10) Pub. No.: US 2026/0312177 A1
(43) Pub. Date: Oct. 8, 2026

(54) Energy Storage System

(71) Applicant: SK On Co., Ltd., Seoul (KR)

(72) Inventor: So Jin KIM, Daejeon (KR)

(21) Appl. No.: 19/563,054

(22) Filed: Mar. 11, 2026

(30) Foreign Application Priority Data
Apr. 3, 2025 (KR) 10-2025-0043595

(51) Int. Cl. H01M 10/6556; A62C 3/06; A62C 3/16; H01M 10/42; H01M 10/613; H01M 10/627; H01M 10/63; H01M 10/6552; H01M 10/6568; H01M 50/251; H01M 50/673

(52) U.S. Cl. CPC H01M 10/6556; A62C 3/06; A62C 3/16; H01M 10/425; H01M 10/613; H01M 10/627; H01M 10/63; H01M 10/6552; H01M 10/6568; H01M 50/251; H01M 50/673

(57) ABSTRACT

The present disclosure relates to an energy storage system. An energy storage system according to an embodiment of the present disclosure may include: a first housing accommodating at least one battery cell; a second housing including an accommodation space accommodating the first housing; a cell cooling portion connected to the first housing and supplying and circulating a coolant to the first housing from the outside of the second housing; a first extinguishing portion branching from the cell cooling portion outside the second housing and supplying the coolant to the accommodation space; and a valve portion provided in at least one of the cell cooling portion or the first extinguishing portion.

### CROSS-REFERENCE TO RELATED APPLICATION(S)

This patent document claims the priority and benefits of Korean Patent Application No. 10-2025-0043595 filed on Apr. 3, 2025, the disclosure of which is incorporated herein by reference in its entirety.

### TECHNICAL FIELD

The present disclosure relates to an energy storage system.

### BACKGROUND

Battery cells are widely used not only in small electronic devices such as mobile phones and laptop computers, but also in medium and large-sized mechanical devices such as electric vehicles (EV), and may be charged and reused.

The electrode of the battery cell may include a cathode and an anode, and each of the cathode and the anode may include a cathode plate including a cathode active material and an anode plate including an anode active material.

An electrode assembly may be formed by interposing a separator between the cathode plate and the anode plate and electrically isolating the cathode plate and the anode plate. The electrode assembly may be manufactured in a stack type, a stack-fold type, a winding type, or the like.

The electrode assembly may be accommodated together with an electrolyte in a case selected for use, such as a pouch type, a prismatic type, and a cylindrical shape, and the case may be sealed to manufacture a battery cell.

Meanwhile, an energy storage system (ESS) is a system or device storing power that has already been produced and supplies the stored power when the power is required, and thus increases the overall efficiency of power use, and may include a plurality of battery cells.

A plurality of battery cells may be provided in the form of a battery module or a battery pack, and a plurality of battery modules or a plurality of battery packs may be accommodated in the energy storage system.

As the demand and supply of such energy storage systems increase, a technology for improving the safety of energy storage systems is required.

### SUMMARY

According to an aspect of the present disclosure, the safety of an energy storage system may be improved.

Furthermore, according to an aspect of the present disclosure, an energy storage system preventing or minimizing the spread of fire may be provided.

Furthermore, the present disclosure may be widely applied to devices within green technology fields such as solar power generation and wind power generation.

Furthermore, the present disclosure may be applied to eco-friendly devices such as eco-friendly electric vehicles and hybrid vehicles, in order to prevent climate change by suppressing air pollution and greenhouse gas emissions.

An energy storage system according to an embodiment of the present disclosure may include: a first housing accommodating at least one battery cell; a second housing including an accommodation space accommodating the first housing; a cell cooling portion connected to the first housing and supplying and circulating a coolant to the first housing from the outside of the second housing; a first extinguishing portion branching from the cell cooling portion outside the second housing and supplying the coolant to the accommodation space; and a valve portion provided in at least one of the cell cooling portion or the first extinguishing portion.

In an embodiment, the second housing may be provided so that at least a portion of the accommodation space is blocked from the outside of the second housing.

In an embodiment, the cell cooling portion may include: a supply pipe supplying the coolant to the first housing; and a discharge pipe receiving the coolant discharged from the first housing.

In an embodiment, the first housing may include a cooling plate facing at least a portion of the at least one battery cell, and the cell cooling portion may include: a supply pipe supplying the coolant to the cooling plate; and a discharge pipe receiving the coolant discharged from the cooling plate.

In an embodiment, the cooling plate may include a hollow portion therein, and the supply pipe and the discharge pipe may be connected to the hollow portion.

In an embodiment, the first housing may accommodate a plurality of battery cells, and the hollow portion may extend from an interior of the cooling plate to face the plurality of battery cells.

In an embodiment, the hollow portion may include: at least one linearly extending straight region; and at least one curved region connected to the at least one straight region and being a rounded region.

In an embodiment, the first extinguishing portion may include: a first extinguishing pipe branching from the supply pipe, and the valve portion may include: a first extinguishing valve provided in a connection area between the first extinguishing pipe and the supply pipe.

In an embodiment, the cell cooling portion may further include: a supply tank connected to the supply pipe via a supply connection pipe and accommodating the coolant, and the first extinguishing valve may include: a three-way valve connected to the supply pipe, the supply connection pipe and the first extinguishing pipe.

In an embodiment, the valve portion may include a discharge valve provided in the discharge pipe.

In an embodiment, a height of a region in which the first extinguishing pipe is connected to the second housing may be greater than or equal to a maximum height of the first housing accommodated within the second housing.

In an embodiment, the first extinguishing pipe may be provided in plural.

In an embodiment, a plurality of first extinguishing pipes may be connected to different areas of the second housing.

In an embodiment, the second housing may include: at least one water level sensor disposed in the accommodation space.

In an embodiment, the second housing may further include: a door opening or closing the accommodation space.

In an embodiment, the energy storage system may further include: a second extinguishing portion connected to the accommodation space and supplying a coolant or an extinguishing agent to the accommodation space outside the second housing.

In an embodiment, the second extinguishing portion may include: a second extinguishing pipe connected to the accommodation space; and an extinguishing tank connected to the second extinguishing pipe, and the valve portion may include: a second extinguishing valve provided in the second extinguishing pipe.

In an embodiment, the energy storage system may further include: a rack frame accommodating at least one second housing; and a controller provided in the rack frame and electrically connected to the at least one battery cell.

In an embodiment, the controller may control the valve portion so that the coolant is supplied to the cell cooling portion or the first extinguishing portion.

According to an aspect of the present disclosure, the safety of an energy storage system is improved.

Additionally, according to an aspect of the present disclosure, provided is an energy storage system in which the transition of fire is prevented or minimized.

Additionally, the present disclosure may be widely applied in green technology fields such as solar power generation and wind power generation.

Additionally, the present disclosure may be applied to eco-friendly devices such as electric vehicles and hybrid vehicles for prevent climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a perspective view schematically illustrating an energy storage system according to an embodiment of the present disclosure.

FIG. 2 is a perspective view schematically illustrating a portion of an energy storage system according to an embodiment of the present disclosure.

FIG. 3 is a schematic exploded perspective view of a first housing according to an embodiment of the present disclosure.

FIG. 4 is a schematic front view of a first housing and a second housing according to an embodiment of the present disclosure.

FIG. 5 is a schematic front view of a first housing and a second housing according to another embodiment of the present disclosure.

FIG. 6 is a schematic front view of a first housing and a second housing according to another embodiment of the present disclosure.

FIG. 7 is a perspective view schematically illustrating a second housing according to another embodiment of the present disclosure.

FIG. 8 is a perspective view schematically illustrating a portion of an energy storage system according to another embodiment of the present disclosure.

FIG. 9 is a schematic side view of an energy storage system according to another embodiment of the present disclosure.

### DETAILED DESCRIPTION

In order to help understand the description of an embodiment of the present disclosure, elements described with the same symbol in the attached drawings are the same elements. Some components of the attached drawings are exaggerated, omitted, or schematically illustrated, and sizes of each component does not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings. However, this is are merely exemplary, and the present disclosure is not limited to the specific embodiments described as examples.

An “embodiment” mentioned below do not necessarily refer to the same embodiment. Specific features, structures, or characteristics may be combined or substituted in any suitable manner consistent with the present disclosure.

Hereinafter, an X-axis depicted in the drawings represents a width direction of a battery cell, a Y-axis represents a height direction of the battery cell, and a Z-axis represents a thickness direction of the battery cell. However, these directions are arbitrarily set for ease of understanding, and the above-described directions may be changed.

In the attached drawings, a point at which the X-axis, Y-axis, and Z-axis intersect may be an origin or zero point. Any area in the attached drawings may be the origin or zero point. The X-axis, Y-axis, and Z-axis depicted in the attached drawings are depicted in a positive (+) direction, and a negative (−) direction relative to the origin or zero point may be understood as an opposite direction to the positive (+) direction.

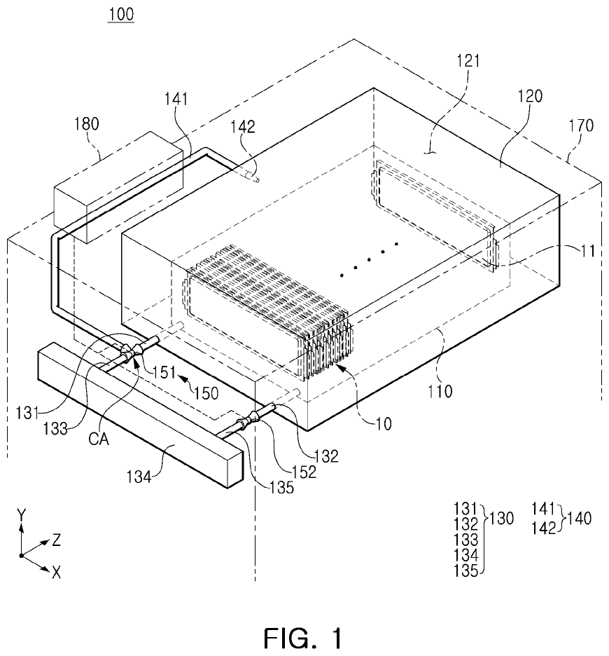

FIG. 1 is a perspective view schematically illustrating an energy storage system 100 according to an embodiment of the present disclosure. As illustrated in FIG. 1, the energy storage system 100 according to an embodiment of the present disclosure may include a rack frame 170 accommodating at least one battery cell 11. The rack frame 170 may form an exterior of the energy storage system 100. The rack frame 170 may include a space capable of accommodating at least one battery cell 11.

In an embodiment, the rack frame 170 may accommodate at least one battery module and/or battery pack. The battery module and/or the battery pack may include a plurality of battery cells 11.

In an embodiment, the rack frame 170 may include a controller 180. The controller 180 may be electrically connected to at least one battery cell 11. Furthermore, for example, the controller 180 may be electrically connected to a battery module and/or a battery pack accommodated in the rack frame 170.

In an embodiment, the controller 180 may include at least one of a Battery Management System (BMS) or a Battery Protection Unit (BPU). The controller 180 may monitor a current, voltage, a temperature, and the like, of the battery cell 11, and may include a means for appropriately maintaining the current, the voltage, the temperature, and the like. In addition, the controller 180 may control the charging and discharging of the battery cell 11.

In an embodiment of the present disclosure, the energy storage system 100 according to an embodiment of the present disclosure may include: a first housing 110 accommodating at least one battery cell 11; a second housing 120 including an accommodation space 121 accommodating the first housing 110; a cell cooling portion 130 connected to the first housing 110 and supplying and circulating a coolant to the first housing 110 from the outside of the second housing; a first extinguishing portion 140 branching from the cell cooling portion 130 outside the second housing and supplying the coolant to the accommodation space 121; and a valve portion 150 provided in at least one of the cell cooling portion 130 and the first extinguishing portion 140.

In an embodiment, the cell cooling portion 130 may include a supply pipe 131 supplying the coolant to the first housing 110 and a discharge pipe 132 receiving the coolant discharged from the first housing 110.

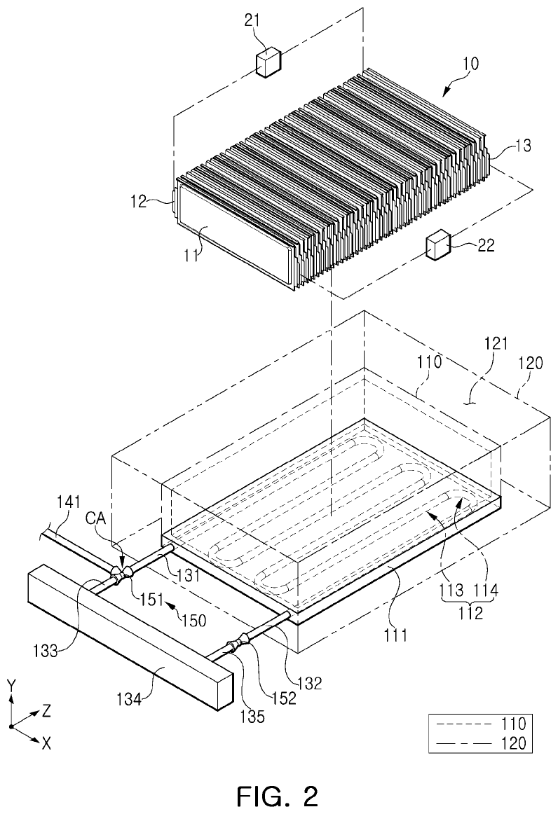

FIG. 2 is a perspective view schematically illustrating a portion of an energy storage system according to an embodiment of the present disclosure. As illustrated in FIGS. 1 and 2, an energy storage system 100 according to an embodiment of the present disclosure may include: a first housing 110 accommodating at least one battery cell 11; a second housing 120 including an accommodation space 121 accommodating the first housing 110; a cell cooling portion 130 connected to the first housing 110 and circulating a coolant through the first housing 110; a first extinguishing portion 140 branching from the cell cooling portion 130 and supplying the coolant to the accommodation space 121; and a valve portion 150 provided in at least one of the cell cooling portion 130 or the first extinguishing portion 140.

The second housing 120 may be accommodated in the rack frame 170. The second housing 120 may be mounted on the rack frame 170 and may be fixed to the rack frame 170, if necessary. The second housing 120 may include an accommodation space 121 having a volume greater than a volume of the first housing 110. A coolant may accumulate in an area of the second housing 120 excluding the first housing 110.

For example, the first housing 110 may accommodate a plurality of battery cells 11. The plurality of battery cells 11 accommodated in the first housing 110 may be stacked or arranged.

The plurality of battery cells 11 may form a battery cell assembly 10. For example, a first electrode lead 12 of the battery cell 11 may be electrically connected to a first busbar assembly 21, and a second electrode lead 13 of the battery cell 11 may be electrically connected to a second busbar assembly 22.

The first electrode lead 12 may be an anode of the battery cell 11, and the second electrode lead 13 may be a cathode of the battery cell 11. However, the first electrode lead 12 may be the cathode, and the second electrode lead 13 may be the anode. The plurality of battery cells 11 included in the battery cell assembly 10 may be electrically connected to each other in at least one of series, parallel, or combinations of series and parallel.

Each of the first busbar assembly 21 and the second busbar assembly 22 may include a busbar member and a busbar plate supporting the busbar member. The busbar member may be formed of an electrically conductive material, and the busbar plate may include a region formed of an electrically insulating material.

In an embodiment, the first busbar assembly 21 and the second busbar assembly 22 may be electrically connected to the controller 180.

The first housing 110 may accommodate a plurality of battery cells 11, the first busbar assembly 21, and the second busbar assembly 22.

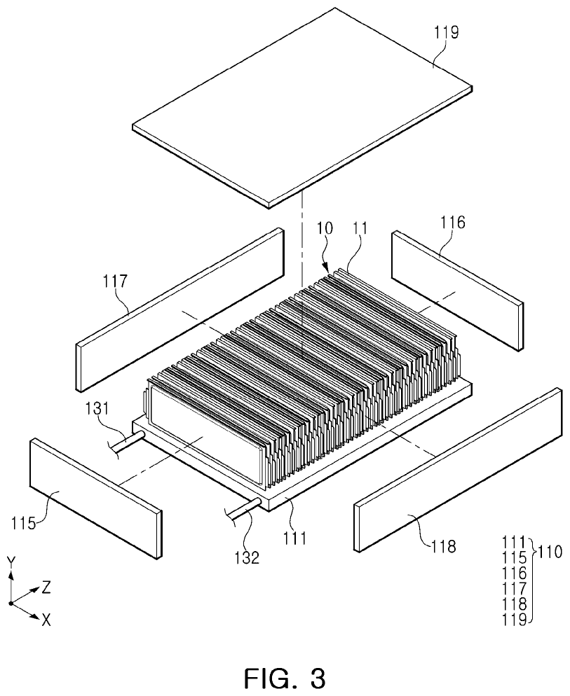

FIG. 3 is a schematic exploded perspective view of the first housing 110 according to an embodiment of the present disclosure. As illustrated in FIG. 3, in an embodiment of the present disclosure, the first housing 110 may form an exterior of a battery module and/or a battery pack.

In an embodiment, the first housing 110 may include a first plate 115 facing a front surface of the battery cell assembly 10, a second plate 116 facing a rear surface of the battery cell assembly 10, a third plate 117 facing one surface of the battery cell assembly 10, and a fourth plate 118 facing the other surface of the battery cell assembly 10. In this case, the first busbar assembly 21 and the second busbar assembly 22 may be disposed between the plurality of battery cells 11 and the third plate 117 and between the plurality of battery cells 11 and the fourth plate 118.

Furthermore, in an embodiment, the first housing 110 may further include a fifth plate 119 facing an upper portion of the battery cell assembly 10. The fifth plate 119 may cover upper portions of the plurality of battery cells 11 and may be connected to the first plate 115, the second plate 116, the third plate 117 and the fourth plate 118, thereby protecting the plurality of battery cells 11 from the outside of the first housing 110.

Furthermore, in an embodiment, at least one of the first plate 115, the second plate 116, the third plate 117, the fourth plate 118 or the fifth plate 119 may be provided with at least one venting hole.

As illustrated in FIGS. 1 to 3, in an embodiment of the present disclosure, the first housing 110 may include a cooling plate 111 facing at least a portion of at least one battery cell 11. The cooling plate 111 may be disposed in a lower portion of the plurality of battery cells 11. For example, the cooling plate 111 may be disposed in a lower portion of the plurality of battery cells 11 in a-Y-direction. The cooling plate 111 may face bottoms of the plurality of battery cells 11.

In an embodiment, the plurality of battery cells 11 may be mounted on one surface of the cooling plate 111. In some cases, a separate heat transfer material, an adhesive, tape, or the like, may be further provided between the plurality of battery cells 11 and the cooling plate 111, but the present disclosure is not limited thereto.

The cooling plate 111 may also be connected to the first plate 115, the second plate 116, the third plate 117 and the fourth plate 118. Accordingly, the plurality of battery cells 11 may be surrounded by the cooling plate 111, the first plate 115, the second plate 116, the third plate 117, the fourth plate 118 and the fifth plate 119. Accordingly, not only may the battery cell 11 be protected from external impacts, but a fire event occurring inside the battery cell 11 may also be prevented from leaking or transferring to the outside of the battery cell 11.

In an embodiment, the cooling plate 111 may include a hollow portion 112 therein. The hollow portion 112 may have a flow path shape. The hollow portion 112 may be an empty space formed within the cooling plate 111.

The hollow portion 112 may be formed in the cooling plate 111 so as to face at least a portion of the plurality of battery cells 11. In an embodiment, the hollow portion 112 may extend within the cooling plate 111 so as to face at least a portion of the plurality of battery cells 11.

The coolant may be circulated within the hollow portion 112 using the method described below. The coolant may flow along the hollow portion 112. The coolant may exchange heat with the plurality of battery cells 11 to cool the plurality of battery cells 11.

In an embodiment, the hollow portion 112 may include at least one linearly extending straight region 113 and at least one curved region 114 connected to the at least one straight region 113, which is a rounded area. The straight region 113 and the curved region 114 may be provided in plural. The straight region 113 and the curved region 114 may be arranged alternately on the cooling plate 111.

For example, the hollow portion 112 may include a region having a “U” shape in a thickness-wise cross-section (X-Z plane) of the battery cell 11.

Accordingly, the coolant may easily flow within the hollow portion 112. Furthermore, within a limited area of the cooling plate 111, an area of a region in which the hollow portion 112 and the plurality of battery cells 11 face each other may be implemented maximally.

Accordingly, the cooling efficiency of the battery cell 11 may be improved, and the safety of the energy storage system 100 may be improved.

In an embodiment, the cell cooling portion 130 may include a supply pipe 131 that supplies the coolant to the cooling plate 111 and a discharge pipe 132 that receives the coolant discharged from the cooling plate 111.

For example, the supply pipe 131 and the discharge pipe 132 may be connected to the hollow portion 112 formed in the cooling plate 111.

The supply pipe 131 and the discharge pipe 132 may extend to the exterior of the first housing 110 and the second housing 120. The supply pipe 131 and the discharge pipe 132 may include a tube, a pipe, or the like. In some cases, the supply pipe 131 and the discharge pipe 132 may include a flexible pipe or tube. Furthermore, the pipe described below may include a tube, a hose, and the like, which may be components including a space through which fluid may flow.

The coolant may be supplied to the hollow portion 112 through the supply pipe 131, and the coolant introduced into the hollow portion 112 may flow along the hollow portion 112 and may be discharged to the outside of the hollow portion 112 through the discharge pipe 132.

In an embodiment, the cell cooling portion 130 may further include a supply tank 134 connected to the supply pipe 131 by a supply connection pipe 133, and accommodating the coolant.

The coolant may be accommodated in the supply tank 134. The supply tank 134 may further include a pump or the like for supplying the coolant.

Additionally, in an embodiment, the supply tank 134 may be connected to a discharge connection pipe 135. The discharge connection pipe 135 may be connected to the discharge pipe 132 and may serve as a passage through which coolant discharged from the hollow portion 112 flows into the supply tank 134.

In this case, the discharge connection pipe 135 may further include at least one foreign matter removal filter, a heat exchanger, or the like. This may allow the coolant to be reused. However, in some cases, the coolant discharged through the discharge pipe 132 may be discharged to the outside of the energy storage system 100 through a separate drain pipe.

In an embodiment, the energy storage system 100 may include a first extinguishing portion 140 branching from the cell cooling portion 130 and supplying the coolant to the second housing 120. The first extinguishing portion 140 may supply the coolant to the accommodation space 121 of the second housing 120.

The first extinguishing portion 140 may be branched from the cell cooling portion 130 by the valve portion 150.

In an embodiment, the valve portion 150 may be disposed in a connection portion or a connection area CA between the cell cooling portion 130 and the first extinguishing portion 140.

In an embodiment, the first extinguishing portion 140 may include a first extinguishing pipe 141 branching from the supply pipe 131 of the cell cooling portion 130, and the valve portion 150 may include a first extinguishing valve 151 provided in the connection area CA between the first extinguishing pipe 141 and the supply pipe 131.

In an embodiment, the first extinguishing valve 151 may include a three-way valve connected to the supply pipe 131, the supply connection pipe 133 and the first extinguishing pipe 141.

The first extinguishing valve 151 may allow the coolant to flow from the supply tank 134 to the supply pipe 131, or may supply the coolant from the supply tank 134 to the first extinguishing pipe 141, or may allow the coolant in the supply pipe 131 to be supplied to the first extinguishing pipe 141.

For example, the first extinguishing valve 151 may be provided in the connection area CA where the supply pipe 131, the supply connection pipe 133, and the first extinguishing pipe 141 are connected to each other.

Accordingly, the coolant normally used to cool the battery cell 11 may be utilized for fire suppression in the event of a fire.

In an embodiment, the controller 180 may control the valve portion 150 so that the coolant may be supplied to the cell cooling portion 130 or the first extinguishing portion 140. In an embodiment, the first extinguishing valve 151 may be electrically connected to the controller 180, and an operation of the first extinguishing valve 151 may be controlled by the controller 180.

The controller 180 may control the first extinguishing valve 151 to supply the coolant to the cell cooling portion 130 under normal conditions. Furthermore, the controller 180 may control the first extinguishing valve 151 to stop the supply of the coolant to the cell cooling portion 130 during a fire or other events, and to supply the coolant to the first extinguishing pipe 141.

Furthermore, the controller 180 may control a discharge valve 152 to discharge the coolant through the discharge pipe 132 under normal conditions, and to stop the discharge of the coolant through the discharge pipe 132 during a fire or other event.

In an embodiment, the first extinguishing pipe 141 may be connected to one side of the second housing 120. For example, the first extinguishing pipe 141 may include an extinguishing nozzle 142, and the extinguishing nozzle 142 may be disposed inside the second housing 120. The extinguishing nozzle 142 may be provided in a form of easily spraying the coolant into the accommodation space 121 of the second housing 120. In some cases, a sealing member, or the like, may be further provided in the connection area between the extinguishing nozzle 142 and the second housing 120.

In an embodiment, the controller 180 may control the first extinguishing valve 151 so that the coolant flows from the supply tank 134 to the supply pipe 131 under normal conditions. Accordingly, the coolant may cool a bottom of the battery cell 11 under normal conditions.

Meanwhile, in an embodiment, the valve portion 150 may further include a discharge valve 152 provided in the discharge pipe 132. In this case, one side of the discharge valve 152 may be connected to the discharge pipe 132, and the other side of the discharge valve 152 may be connected to the discharge connection pipe 135.

The discharge valve 152 may allow the coolant discharged from the discharge pipe 132 to be supplied to the discharge connection pipe 135, or may block the coolant discharged from the discharge pipe 132 from being supplied to the discharge connection pipe 135.

The discharge valve 152 may be electrically connected to the controller 180 and may be controlled by the controller 180. The controller 180 may control the discharge valve 152 so that the coolant normally supplied to the discharge pipe 132 may be supplied to the discharge connection pipe 135. Accordingly, the coolant that has completed cooling the battery cell 11 may undergo a separate heat exchange. Such a coolant may also be reused to cool the battery cell 11.

In the event of a fire, the controller 180 may control the first extinguishing valve 151 to block the coolant from flowing to the supply pipe 131. Furthermore, the controller 180 may control the first extinguishing valve 151 so that the coolant may be supplied to the first extinguishing pipe 141. Accordingly, in the event of a fire, the coolant may be supplied to the accommodation space 121 of the second housing 120 to extinguish the fire.

Additionally, in an embodiment, the controller 180 may control the discharge valve 152 to block the supply of the coolant supplied to the discharge pipe 132 to the discharge connection pipe 135 in the event of a fire. However, the present disclosure is not limited thereto.

In an embodiment, the second housing 120 may be provided so that at least a portion of the accommodation space 121 is blocked from the outside of the second housing 120. For example, the second housing 120 may be provided so that the accommodation space 121 in which the first housing 110 is accommodated is blocked from the outside of the second housing 120. In this case, the first extinguishing pipe 141 or the extinguishing nozzle 142 may have a shape penetrating through the second housing 120, and at least a portion of the first extinguishing pipe 141 or the extinguishing nozzle 142 may be inserted into the second housing 120 and may be disposed in the accommodation space 121.

Accordingly, the coolant supplied to the accommodation space 121 may be accumulated in the accommodation space 121. When the coolant may be continuously supplied to the second housing 120, the first housing 110 may be immersed or submerged in the coolant. Accordingly, if a fire, explosion, or the like, occurs due to the battery cell 11 accommodated in the first housing 110, the coolant may be allowed to be supplied to the second housing 120, so that the first housing 110 may be immersed or submerged in the coolant. Accordingly, any thermal event (e.g., fire, explosion, etc.) occurring in the battery cell 11may be suppressed.

Accordingly, the first housing 110 may be immersed or submerged in the coolant, which may allow for the early extinguishment of a fire occurring in the first housing 110. Furthermore, the spread of the fire originating in the first housing 110 to the outside of the first housing 110 or the second housing 120 may be prevented or minimized.

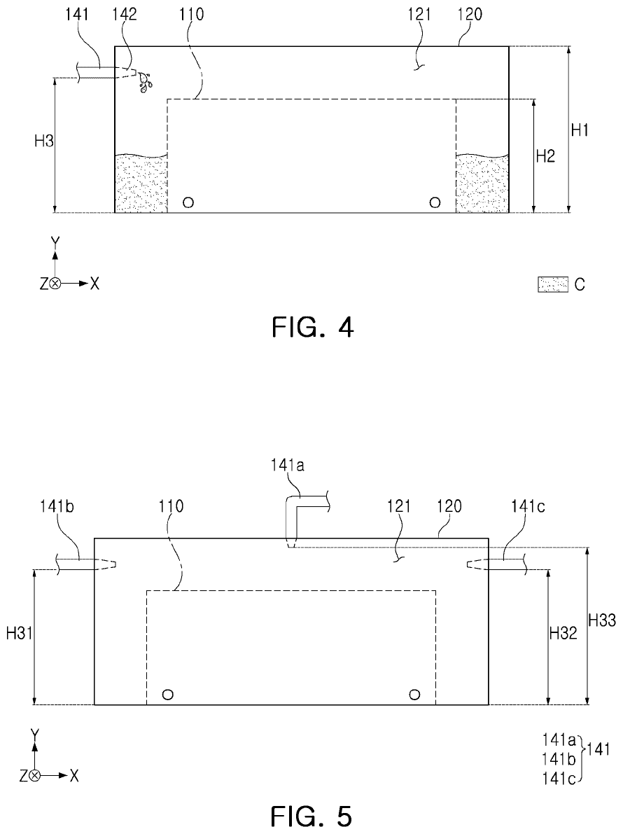

FIG. 4 is a schematic front view of a first housing 110 and a second housing 120 according to an embodiment of the present disclosure.

As illustrated in FIG. 4, in an embodiment of the present disclosure, a height of a region in which the first extinguishing pipe 141 is connected to the second housing 120 may be greater than or equal to a maximum height of the first housing 110 accommodated within the second housing 120.

For example, in a cross-sectional view (X-Y plane) of the battery cell 11, the second housing 120 may have a first height H1, and the first housing 110 may have a second height H2, and the first extinguishing pipe 141 or the digestive nozzle 142 may have a third height H3. Hereinafter, A case in which the third height H3 is the height of the first extinguishing pipe 141 will be described as an example.

The first height H1 is higher than the second height H2 and the third height H3, and the third height H3 may be higher than the second height H2. Accordingly, the second height H2 may be higher than a height of the battery cell 11. For example, the height of the battery cell 11 may be lower than the second height H2.

Accordingly, when the coolant is discharged from the first extinguishing pipe 141 in the event of a fire, the coolant may be supplied from an upper portion of the battery cell 11 toward a lower portion of the battery cell 11. Accordingly, the fire suppression efficiency or the cooling efficiency of the battery cell 11 may be improved.

Furthermore, depending on the severity of the fire, the battery cell 11 or the first housing 110 may be completely submerged or immersed in the coolant.

FIG. 5 is a schematic front view of the first housing 110 and the second housing 120 according to another embodiment of the present disclosure. As illustrated in FIG. 5, in an embodiment of the present disclosure, the first extinguishing pipe 141 may be provided in plural.

For example, a plurality of first extinguishing pipes 141 may be connected to the first housing 110 in different positions within the second housing 120.

The plurality of first extinguishing pipes 141 may include an upper first extinguishing pipe 141a, a one-side first extinguishing pipe 141b disposed on one side of the second housing 120, and an other-side first extinguishing pipe 141c disposed on the other side of the second housing 120. Each of the plurality of first extinguishing pipes 141 may branch from the supply pipe 131 or the supply connection pipe 133, or may have a form in which one pipe branches into a plurality of pipes after branching from the supply pipe 131 or the supply connection pipe 133. However, the present disclosure is not limited thereto.

Furthermore, if necessary, each of the plurality of first extinguishing pipes 141 may further include a valve for flow control.

In an embodiment, the upper first extinguishing pipe 141a may be connected to an upper portion of the second housing 120, the one-side first extinguishing pipe 141b may be connected to one side of the second housing 120, and the other-side first extinguishing pipe 141c may be connected to the other side of the second housing 120.

The one-side first extinguishing pipe 141b and the other-side first extinguishing pipe 141c may be disposed opposite to each other. In an embodiment, a height H31 of the one-side first extinguishing pipe 141b may be equal to a height H32 of the other-side first extinguishing pipe 141c.

A height H33 of the upper first extinguishing pipe 141a may be equal to or less than a height of the second housing 120, and may be equal to or greater than the height H31 of the one-side first extinguishing pipe 141b, and may be equal to or greater than the height H32 of the other-side first extinguishing pipe 141c.

Accordingly, in the event of a fire, the coolant may be supplied to the accommodation space 121 of the second housing 120 through the upper first extinguishing pipe 141a, the one-side first extinguishing pipe 141b, and the other-side first extinguishing pipe 141c. Accordingly, in the event of a fire, the first housing 110 may be more quickly immersed in the coolant.

In an embodiment, the coolant may be coolant water, but the type of coolant is not necessarily limited by the present disclosure.

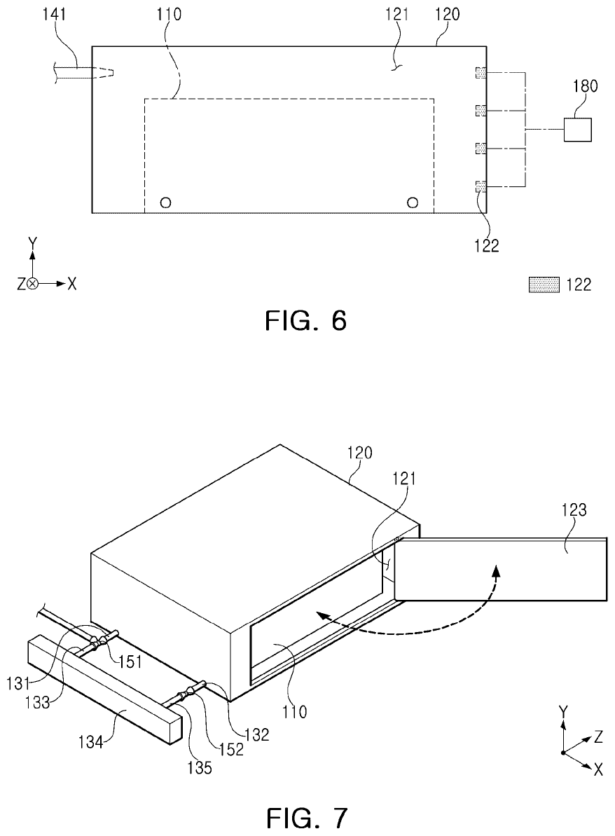

FIG. 6 is a schematic front view of the first housing 110 and the second housing 120 according to another embodiment of the present disclosure. As illustrated in FIG. 6, in an embodiment of the present disclosure, the second housing 120 may include at least one water level sensor 122 disposed in the accommodation space 121.

The at least one water level sensor 122 may include a plurality of water level sensors 122. The plurality of water level sensors 122 may be disposed at different heights in the second housing 120. The plurality of water level sensors 122 may acquire coolant level information in the accommodation space 121.

The water level sensor 122 may be any type of sensor, such as a sound sensor, an ultrasonic sensor, a fluid contact sensor, a camera sensor, or a radar sensor. However, the type of water level sensor 122 is not necessarily limited by the present disclosure.

Each of the plurality of water level sensors 122 may be electrically connected to the controller 180. The controller 180 may receive level information of the coolant from the plurality of water level sensors 122 and may control an operation of the first extinguishing valve 151 based on the received level information.

For example, when a level of the coolant approaches a level of the first extinguishing pipe 141, the controller 180 may close the first extinguishing valve 151, which may block an additional coolant from being supplied into the second housing 120.

Accordingly, when a height of at least one water level sensor 122 is disposed to be the same as a height of the first extinguishing pipe 141, the timing for cutting off coolant supply may be easily determined.

FIG. 7 is a perspective view schematically illustrating a second housing 120 according to another embodiment of the present disclosure. As illustrated in FIG. 7, in an embodiment of the present disclosure, the second housing 120 may further include an opening/closing door 123 opening or closing the accommodation space 121 in which the first housing 110 is accommodated.

The opening/closing door 123 may be connected to the second housing 120 by a hinge or the like. The opening/closing door 123 may further include a handle or the like, as needed.

When a user closes the door 123, the accommodation space 121 is sealed. When the use opens the door 123, the accommodation space 121 may be opened. The user may utilize the door 123 when the first housing 110 is accommodated inside the second housing 120 or the first housing 110 is withdrawn from the inside of the second housing 120.

Accordingly, the assembly efficiency and maintenance efficiency of the energy storage system may be improved.

A sealing member, and the like, may be further provided in a contact portion between the door 123 and the second housing 120. Accordingly, this may enhance the airtightness of the accommodation space 121 and may contribute to prevent the coolant from leaking out of the second housing 120.

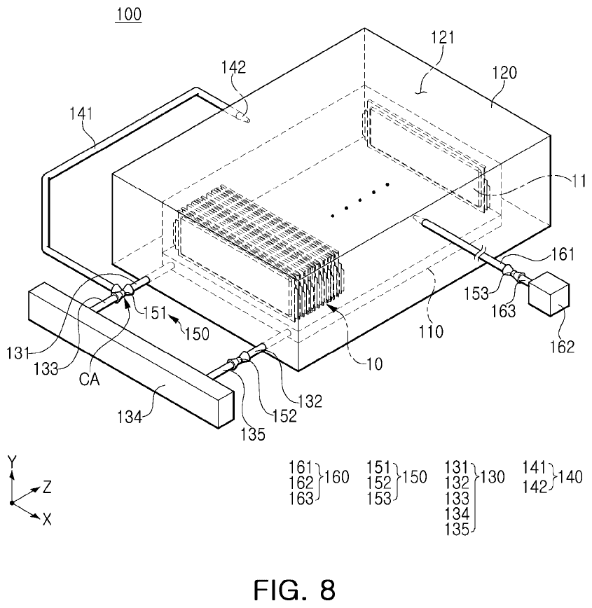

FIG. 8 is a perspective view schematically illustrating a portion of an energy storage system 100 according to another embodiment of the present disclosure. As illustrated in FIG. 8, the energy storage system 100 according to an embodiment of the present disclosure may further include a second extinguishing portion 160 connected to the accommodation space 121 and supplying a coolant or an extinguishing agent to the accommodation space 121 from the outside of the second housing 120.

In an embodiment, the second extinguishing portion 160 may include a second extinguishing pipe 161 connected to the accommodation space 121 and an extinguishing tank 162 connected to the second extinguishing pipe 161 and accommodating the coolant or the extinguishing agent.

The extinguishing tank 162 may accommodate the same type of coolant accommodated in the supply tank 134, or may accommodate a different type of extinguishing agent from the coolant.

A supply portion through which the coolant or the extinguishing agent is sprayed from the second extinguishing pipe 161 may be located within the second housing 120, i.e., within the accommodation space 121. The second extinguishing pipe 161 may extend outside the second housing 120.

In an embodiment, the valve portion 150 may further include a second extinguishing valve 153 provided in the second extinguishing pipe 161. One side of the second extinguishing valve 153 may be connected to the second extinguishing pipe 161, and the other side of the second extinguishing valve 153 may be connected to an extinguishing connection pipe 163. The extinguishing connection pipe 163 may connect the second extinguishing pipe 161 to the extinguishing tank 162.

In an embodiment, the second extinguishing valve 153 may be electrically connected to and controlled by a controller 180. The controller 180 may control the second extinguishing valve 153 to block the supply of fluid to the second housing 120 through the second extinguishing pipe 161 during normal operation, and to allow for the supply of fluid to the second housing 120 through the second extinguishing pipe 161 during a fire. Accordingly, fire suppression efficiency may be improved.

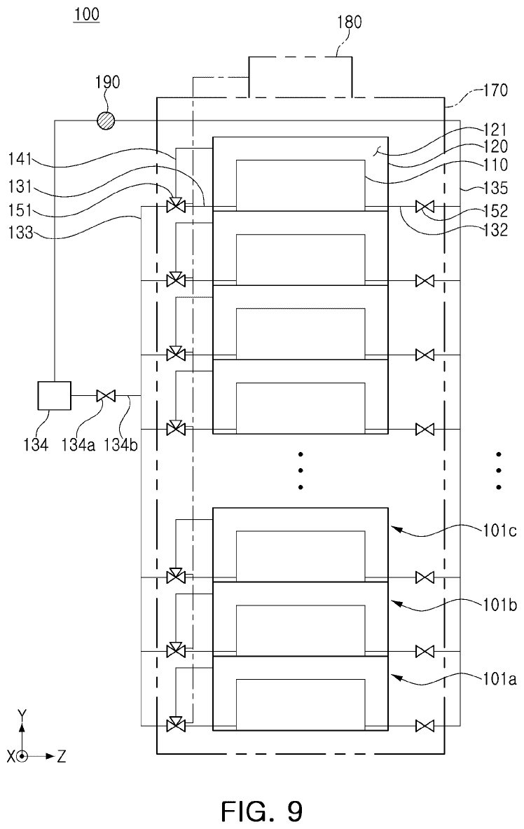

FIG. 9 is a schematic side view of an energy storage system 100 according to another embodiment of the present disclosure.

A rack frame 170 may be provided with a plurality of energy modules 101a, 101b and 101c. Each of the plurality of energy modules 101a, 101b and 101c may include a first housing 110 and a second housing 120. At least one battery cell 11 may be accommodated within the first housing 110. The battery cell 11 may be a secondary battery and may have various shapes, such as a pouch-shaped, square, or cylindrical shape.

The rack frame 170 may have a drawer-type structure, a rail-type structure, or the like, to accommodate a plurality of second housings 120.

Each of the plurality of second housings 120 may have a form in which the first housing 110 is accommodated. Furthermore, the valve portion 150 may be provided outside the second housing 120. Accordingly, even if a plurality of valves malfunction, the battery cell 11 may be protected, and an environment in which the valve portion 150 may operate smoothly may be implemented.

Furthermore, in an embodiment, another auxiliary pipe 134b may be provided to connect the supply tank 134 and the supply connection pipe 133, and the auxiliary pipe 134b may further include a supply valve 134a.

The supply connection pipe 133 may branch to connect to the plurality of second housings 120. The branched supply connection pipes 133 may be connected to a plurality of first supply pipes 131. The plurality of first supply pipes 131 may supply the coolant to the first housing 110 or the cooling plate 111.

The first extinguishing pipe 141 may branch from the first supply pipe 131 or the supply connection pipe 133. Additionally, the first extinguishing valve 151 may be connected to each of the first supply pipe 131, the supply connection pipe 133 and the first extinguishing pipe 141. As described above, the first extinguishing valve 151 may control the flow of the coolant to supply the coolant to the first supply pipe 131 or the first extinguishing pipe 141.

The plurality of first housings 110 and the plurality of second housings 120 provided in the rack frame 170 may be connected or linked to the first extinguishing pipe 141, the first supply pipe 131, and the first extinguishing valve 151, respectively.

Accordingly, under normal conditions, the coolant for cooling the battery cells 11 may be supplied to all first housings 110, and in the event of a fire, the coolant for fire suppression may be supplied to the storage spaces 121 of all second housings 120. Such operations may be performed by the controller 180. The controller 180 may additionally include an emergency power source, or the like.

If necessary, each second housing 120 may be provided with a fire detection sensor, and the fire detection sensor may be connected to the controller 180. Accordingly, the controller 180 may control the supply of the coolant or the extinguishing agent to the second housing 120 in which a fire is determined to have occurred.

The coolant discharged from the plurality of first housings 110 or the plurality of cooling plates 111 may be discharged through the discharge pipe 132. As described above, the discharge pipe 132 may be provided with a discharge valve 152, and the discharge valve 152 may be electrically connected to the controller 180.

The plurality of discharge pipes 132 may be connected to the discharge connection pipe 135. The discharge connection pipe 135 may be connected to the supply tank 134.

In an embodiment, the discharge connection pipe 135 may further include a filter member 190. The filter member 190 may filter foreign substances included in in the coolant.

Furthermore, in an embodiment, a heat exchanger may be connected to the discharge connection pipe 135. Accordingly, a temperature of the coolant that has completed cooling the battery cell 11 may be lowered, and the coolant, whose temperature has been relatively lowered, may be introduced into the supply tank 134. In this case, the coolant may be recycled for cooling the battery cell 11.

The above-described explanation is merely an example of applying the principles of the present disclosure, and other components may be included or substituted without departing from the scope of the present disclosure. Furthermore, the above-described embodiments may be substituted or combined with each other.

What is claimed is:

1. An energy storage system, comprising:
a first housing accommodating at least one battery cell;
a second housing including an accommodation space accommodating the first housing;
a cell cooling portion connected to the first housing and supplying and circulating a coolant to the first housing from the outside of the second housing;
a first extinguishing portion branching from the cell cooling portion outside the second housing and supplying the coolant to the accommodation space; and
a valve portion provided in at least one of the cell cooling portion or the first extinguishing portion.

2. The energy storage system of claim 1, wherein the second housing is provided so that at least a portion of the accommodation space is blocked from the outside of the second housing.

3. The energy storage system of claim 1, wherein the cell cooling portion includes:
a supply pipe supplying the coolant to the first housing; and
a discharge pipe receiving the coolant discharged from the first housing.

4. The energy storage system of claim 1, wherein the first housing includes a cooling plate facing at least a portion of the at least one battery cell, and
the cell cooling portion includes:
a supply pipe supplying the coolant to the cooling plate; and
a discharge pipe receiving the coolant discharged from the cooling plate.

5. The energy storage system of claim 4, wherein the cooling plate includes a hollow portion therein, and
the supply pipe and the discharge pipe are connected to the hollow portion.

6. The energy storage system of claim 5, wherein the first housing accommodates a plurality of battery cells, and
the hollow portion extends from an interior of the cooling plate to face the plurality of battery cells.

7. The energy storage system of claim 6, wherein the hollow portion includes:
at least one linearly extending straight region; and
at least one curved region connected to the at least one straight region and being a rounded region.

8. The energy storage system of claim 4, wherein the first extinguishing portion includes:
a first extinguishing pipe branching from the supply pipe, and
the valve portion includes:
a first extinguishing valve provided in a connection area between the first extinguishing pipe and the supply pipe.

9. The energy storage system of claim 8, wherein the cell cooling portion further includes:
a supply tank connected to the supply pipe via a supply connection pipe and accommodating the coolant, and
the first extinguishing valve includes:
a three-way valve connected to the supply pipe, the supply connection pipe and the first extinguishing pipe.

10. The energy storage system of claim 4, wherein the valve portion includes:
a discharge valve provided in the discharge pipe.

11. The energy storage system of claim 8, wherein a height of a region in which the first extinguishing pipe is connected to the second housing is greater than or equal to a maximum height of the first housing accommodated within the second housing.

12. The energy storage system of claim 8, wherein the first extinguishing pipe is provided in plural.

13. The energy storage system of claim 12, wherein a plurality of first extinguishing pipes are connected to different regions of the second housing.

14. The energy storage system of claim 1, wherein the second housing includes:
at least one water level sensor disposed in the accommodation space.

15. The energy storage system of claim 1, wherein the second housing further includes:
a door opening or closing the accommodation space.

16. The energy storage system of claim 1, further comprising:
a second extinguishing portion connected to the accommodation space and supplying a coolant or an extinguishing agent to the accommodation space outside the second housing.

17. The energy storage system of claim 16, wherein the second extinguishing portion includes:
a second extinguishing pipe connected to the accommodation space; and
an extinguishing tank connected to the second extinguishing pipe, and
the valve portion includes:
a second extinguishing valve provided in the second extinguishing pipe.

18. The energy storage system of claim 1, further comprising:
a rack frame accommodating at least one second housing; and
a controller provided in the rack frame and electrically connected to the at least one battery cell.

19. The energy storage system of claim 18, wherein the controller controls the valve portion so that the coolant is supplied to the cell cooling portion or the first extinguishing portion.
